(19) United States
(12) Patent Application Publication
(10) Pub. No.: US 2020/0364728 A1
(43) Pub. Date: Nov. 19, 2020

(54) METHOD OF COMPARISON-BASED RANKING

(71) Applicant: Samsung Electronics Co., Ltd., Suwon-si (KR)

(72) Inventors: Dongyun Jin, San Jose, CA (US); Zhi Nie, Sunnyvale, CA (US); Rishikesh Ghewari, Sunnyvale, CA (US); Rezwana Karim, Sunnyvale, CA (US); Mingyang Wang, Santa Clara, CA (US); Dongjin Lee, San Jose, CA (US); Yinan Li, Mountain View, CA (US)

(21) Appl. No.: 16/870,818

(22) Filed: May 8, 2020

Related U.S. Application Data
(60) Provisional application No. 62/847,254, filed on May 13, 2019.

(51) Int. Cl. G06Q 30/02; G06F 16/9038; G06F 16/9035

(52) U.S. Cl. CPC G06Q 30/0201; G06F 16/9035; G06F 16/9038; G06Q 30/0205

(57) ABSTRACT

A method of providing a comparison-based ranked output includes extracting a plurality of pairwise comparisons between transaction objects, from a data set comprising transaction histories of one or more users' transactions with transaction objects over time. The method includes determining a plurality of user groups, wherein each user group of the plurality of user groups is associated with a common level feature among a set of transaction objects. For each transaction object, a present height associated with the transaction object based on the extracted plurality of pairwise comparisons is determined. Further, the method includes generating, based on a comparison of present heights of transaction objects associated with the common level feature, a data object comprising a ranking of transaction objects for a user group of the plurality of user groups, and providing the data object to an application to provide a user interface based on the ranking of transaction objects.

### CROSS-REFERENCE TO RELATED APPLICATION AND CLAIM OF PRIORITY

This application claims priority under 35 U.S.C. § 119(e) to U.S. Provisional Patent Application No. 62/847,254 filed on May 13, 2019. The above-identified provisional patent application is hereby incorporated by reference in its entirety.

### TECHNICAL FIELD

This disclosure relates generally to electronic search and in particular, providing users of electronic devices with relevant information in a computationally efficient manner. In particular, the present disclosure is directed to systems and methods for comparison-based ranking.

### BACKGROUND

Advances in, without limitation, battery design, wireless networks, and back-end processing capability have ushered in an era in which the core functionalities of many networks of processor-based devices (for example, mobile terminals, such as smartphones, and backend cloud computing systems) include the rapid provision of information that is personalized for a user, or otherwise contextually tuned to maximize its relevance. User provided ratings and rankings of objects of interest (for example, star ratings provided by visitors to a restaurant) comprise one dimension along which information can be made more relevant for users generally. From such ratings, information on objects of interest can be presented in a ranked manner, thereby creating some probability by which a user is presented with the most relevant objects of interest.

Improving computational efficiency, relevance and tunability of the rankings within the result set remain a source of technical challenges and opportunities for improvements in the performance of computing platforms as tools for providing contextually curated information.

### SUMMARY

This disclosure provides a method of comparison based ranking.

In a first embodiment, a method of providing a comparison-based ranked output includes, at an apparatus comprising a processor and a non-transitory memory, extracting a plurality of pairwise comparisons between transaction objects, from a data set stored in the non-transitory memory, the data set comprising transaction histories of one or more users' transactions with transaction objects over time. The method further includes from the stored data set, determining a plurality of user groups, wherein each user group of the plurality of user groups is associated with a common level feature among a set of transaction objects. For each transaction object, a present height associated with the transaction object based on the extracted plurality of pairwise comparisons is determined. Further, the method includes generating, based on a comparison of present heights of transaction objects associated with the common level feature, a data object comprising a ranking of transaction objects for a user group of the plurality of user groups. Additionally, the method includes providing the data object to an application to provide a user interface based on the ranking of transaction objects.

In a second embodiment, an apparatus includes a processor and a memory. The memory includes instructions, which, when executed by the processor cause the apparatus to extract a plurality of pairwise comparisons between transaction objects, from a data set stored in the memory, the data set comprising transaction histories of one or more users' transactions with transaction objects over time. The instructions further cause the apparatus to, from the stored data set, determine a plurality of user groups, wherein each user group of the plurality of user groups is associated with a common level feature among a set of transaction objects. Additionally, the instructions cause the apparatus to, for each transaction object, determine a present height associated with the transaction object based on the extracted plurality of pairwise comparisons. Additionally, the instructions cause the apparatus to generate, based on a comparison of present heights of transaction objects associated with the common level feature, a data object comprising a ranking of transaction objects for a user group of the plurality of user groups. Further, the instructions, when executed, cause the apparatus to provide the data object to an application to provide a user interface based on the ranking of transaction objects.

In a third embodiment, a non-transitory, computer-readable medium contains instructions, which when executed by a processor, cause an apparatus to extract a plurality of pairwise comparisons between transaction objects, from a data set stored in the memory, the data set comprising transaction histories of one or more users' transactions with transaction objects over time. When executed, the instructions further cause the apparatus to, from the stored data set, determine a plurality of user groups, wherein each user group of the plurality of user groups is associated with a common level feature among a set of transaction objects. When executed, the instructions also cause the apparatus to, for each transaction object, determine a present height associated with the transaction object based on the extracted plurality of pairwise comparisons. Additionally, when executed, the instructions cause the apparatus to generate, based on a comparison of present heights of transaction objects associated with the common level feature, a data object comprising a ranking of transaction objects for a user group of the plurality of user groups. Further, when executed, the instructions cause the apparatus to provide the data object to an application to provide a user interface based on the ranking of transaction objects.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of an apparatus, such as a mobile terminal, according to certain embodiments of this disclosure;

FIG. 2 illustrates an example of a server according to some embodiments of this disclosure;

FIG. 3A illustrates an example of a transaction history according to certain embodiments of this disclosure;

FIG. 3B illustrates three examples of pairwise comparisons extracted from a transaction history, according to various embodiments of this disclosure;

FIG. 4 illustrates an example of a method for extracting pairwise comparisons from a transaction history, according to various embodiments of this disclosure;

FIG. 5 illustrates an example of a hierarchy among user groups generated according to certain embodiments of this disclosure;

FIG. 6A illustrates an example of a logical architecture for implementing a gravity ranking algorithm for generating rankings between transaction objects based on pairwise comparisons according to various embodiments of this disclosure;

FIG. 6B illustrates an example of a set of heights for transaction objects according to some embodiments of this disclosure;

FIG. 7 illustrates an example of a ranking of transaction objects across user groups output by certain embodiments of this disclosure;

FIGS. 8A and 8B illustrate examples of user interfaces of an application provided at an electronic device for providing user group-mapped rankings of transaction objects according to various embodiments of this disclosure; and

FIG. 9 illustrates an example of operations of a method for obtaining a ranking of transaction objects from a data set comprising transaction histories of one or more users' transactions, according to various embodiments of this disclosure.

### DETAILED DESCRIPTION

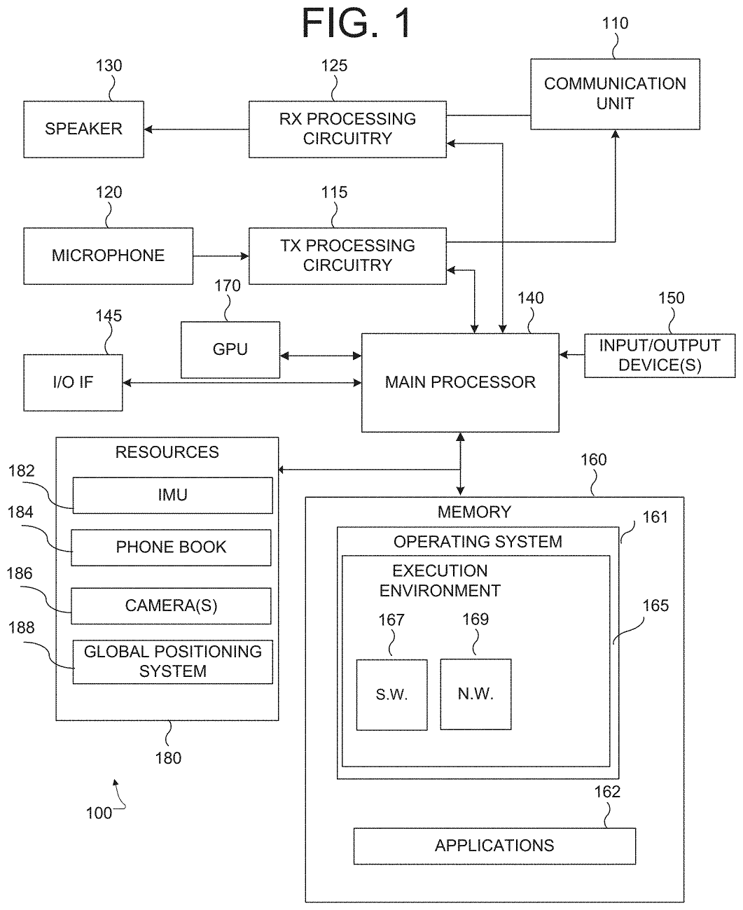

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

FIG. 1 illustrates a non-limiting example of a device for performing or providing comparison based rankings of objects according to this disclosure. The embodiment of device 100 illustrated in FIG. 1 is for illustration only, and other configurations are possible. However, suitable devices come in a wide variety of configurations, and FIG. 1 does not limit the scope of this disclosure to any particular implementation of a device.

As shown in the non-limiting example of FIG. 1, the device 100 includes a communication unit 110 that may include, for example, a radio frequency (RF) transceiver, a BLUETOOTH transceiver, or a WI-FI transceiver, etc., transmit (TX) processing circuitry 115, a microphone 120, and receive (RX) processing circuitry 125. The device 100 also includes a speaker 130, a main processor 140, an input/output (I/O) interface (IF) 145, input/output device(s) 150, and a memory 160. The memory 160 includes an operating system (OS) program 161 and one or more applications 162.

Applications 162 can include games, social media applications, applications for geotagging photographs and other items of digital content, virtual reality (VR) applications, augmented reality (AR) applications, operating systems, device security (e.g., anti-theft and device tracking) applications or any other applications that access resources of device 100, the resources of device 100 including, without limitation, speaker 130, microphone 120, input/output devices 150, and additional resources 180. According to certain embodiments, applications 162 may include applications configured to provide navigation and/or search functionalities, such as a map application providing search results for locations (for example, restaurants) likely to match a user's preferences. Further, applications 162 may include applications containing program code that when executed by a processor, such as main processor 140, cause the processor to submit requests for, and receive ranked sets of transaction objects (for example, products of interest) according to certain embodiments of the present disclosure.

The communication unit 110 may receive an incoming RF signal, for example, a near field communication signal such as a BLUETOOTH or WI-FI signal. The communication unit 110 can down-convert the incoming RF signal to generate an intermediate frequency (IF) or baseband signal. The IF or baseband signal is sent to the RX processing circuitry 125, which generates a processed baseband signal by filtering, decoding, or digitizing the baseband or IF signal. The RX processing circuitry 125 transmits the processed baseband signal to the speaker 130 (such as for voice data) or to the main processor 140 for further processing (such as for web browsing data, online gameplay data, notification data, or other message data). Additionally, communication unit 110 may contain a network interface, such as a network card, or a network interface implemented through software.

The TX processing circuitry 115 receives analog or digital voice data from the microphone 120 or other outgoing baseband data (such as web data, e-mail, or interactive video game data) from the main processor 140. The TX processing circuitry 115 encodes, multiplexes, or digitizes the outgoing baseband data to generate a processed baseband or IF signal. The communication unit 110 receives the outgoing processed baseband or IF signal from the TX processing circuitry 115 and up-converts the baseband or IF signal to an RF signal for transmission.

The main processor 140 can include one or more processors, processing circuitry, or other processing devices and execute the OS program 161 stored in the memory 160 in order to control the overall operation of the device 100. For example, the main processor 140 could control the reception of forward channel signals and the transmission of reverse channel signals by the communication unit 110, the RX processing circuitry 125, and the TX processing circuitry 115 in accordance with well-known principles. In some embodiments, the main processor 140 includes at least one microprocessor or microcontroller.

Additionally, operating system 161 is capable of providing an execution environment 165 for applications. According to some embodiments, execution environment 165 includes a “secure world” 167 and a “normal world” 169. According to certain embodiments, certain memory and processor resources accessible in “secure world” 167 are not accessible to applications running in “normal world” 169. In some embodiments, “secure world” execution environment 167 provides a trusted user interface through which content associated with sensitive device functionalities (for example, payments to be made using a mobile wallet application) can be rendered and displayed for a user.

The main processor 140 is also capable of executing other processes and programs resident in the memory 160. The main processor 140 can move data into or out of the memory 160 as required by an executing process. In some embodiments, the main processor 140 is configured to execute the applications 162 based on the OS program 161 or in response to inputs from a user or applications 162. Applications 162 can include applications specifically developed for the platform of device 100, or legacy applications developed for earlier platforms. The main processor 140 is also coupled to the I/O interface 145, which provides the device 100 with the ability to connect to other devices such as laptop computers and handheld computers. The I/O interface 145 is the communication path between these accessories and the main processor 140.

The main processor 140 is also coupled to the input/output device(s) 150. The operator of the device 100 can use the input/output device(s) 150 to enter data into the device 100. Input/output device(s) 150 can include keyboards, touch screens, mouse(s), track balls or other devices capable of acting as a user interface to allow a user to interact with electronic device 100. In some embodiments, input/output device(s) 150 can include a touch panel, a virtual reality headset, a (digital) pen sensor, a key, or an ultrasonic input device.

Input/output device(s) 150 can include one or more screens, which can be a liquid crystal display, light-emitting diode (LED) display, an optical LED (OLED), an active matrix OLED (AMOLED), or other screens capable of rendering graphics.

The memory 160 is coupled to the main processor 140. According to certain embodiments, part of the memory 160 includes a random access memory (RAM), and another part of the memory 160 includes a Flash memory or other read-only memory (ROM). Although FIG. 1 illustrates one example of a device 100. Various changes can be made to FIG. 1.

For example, according to certain embodiments, device 100 can further include a separate graphics processing unit (GPU) 170.

According to certain embodiments, electronic device 100 includes a variety of additional resources 180 which can, if permitted, be accessed by applications 162. According to certain embodiments, resources 180 include an accelerometer or inertial motion unit 182, which can detect movements of the electronic device along one or more degrees of freedom. Additional resources 180 include, in some embodiments, a user's phone book 184, one or more cameras 186 of electronic device 100, and a global positioning system 188.

Although FIG. 1 illustrates one example of a device 100 for generating and receiving comparison based rankings of information and transaction objects, various changes may be made to FIG. 1. For example, the device 100 could include any number of components in any suitable arrangement. In general, devices including computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

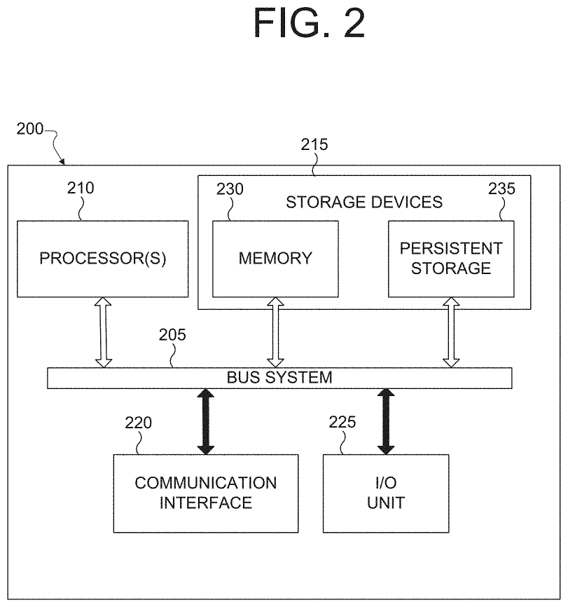

FIG. 2 illustrates an example of a server 200 according to various embodiments of this disclosure. According to certain embodiments, server 200 may be communicatively connected (for example, over a wireless communication network, such as a 5G network) to device 100 in FIG. 1. According to certain embodiments, server 200 can be configured to generate comparison-based rankings of items of information (also referred to herein as “transaction objects”) and provide same to user equipment (for example, device 100 in FIG. 1) over one or more networks.

Server 200 can, in some embodiments, be embodied on a single standalone device, or on a device providing another server function (for example, a gateway server). Alternatively, in some cases, server 200 may be embodied on multiple machines, for example a server communicatively connected to one or more database servers. According to still further embodiments, server 200 is embodied on a cloud computing platform.

As shown in FIG. 2, server 200 includes a bus system 205 that supports communication between at least one processing device 210, at least one storage device(s) 215, at least one communications unit 220, and at least one input/output (I/O) unit 225.

The processing device 210 executes instructions that can be stored in a memory 230. The processing device 210 can include any suitable number(s) and type(s) of processors, processing circuitry, or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term data or instruction storage. According to certain embodiments, persistent storage 235 comprises one or databases or interfaces to databases embodied on separate machines. storage of data, such as a ready only memory, hard drive, flash memory, or optical disc.

The communications unit 220 supports communications with other systems or devices. For example, the communications unit 220 can include a network interface card or a wireless transceiver facilitating communications over the network 102. The communications unit 220 can support communications through any suitable physical or wireless communication link(s).

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device.

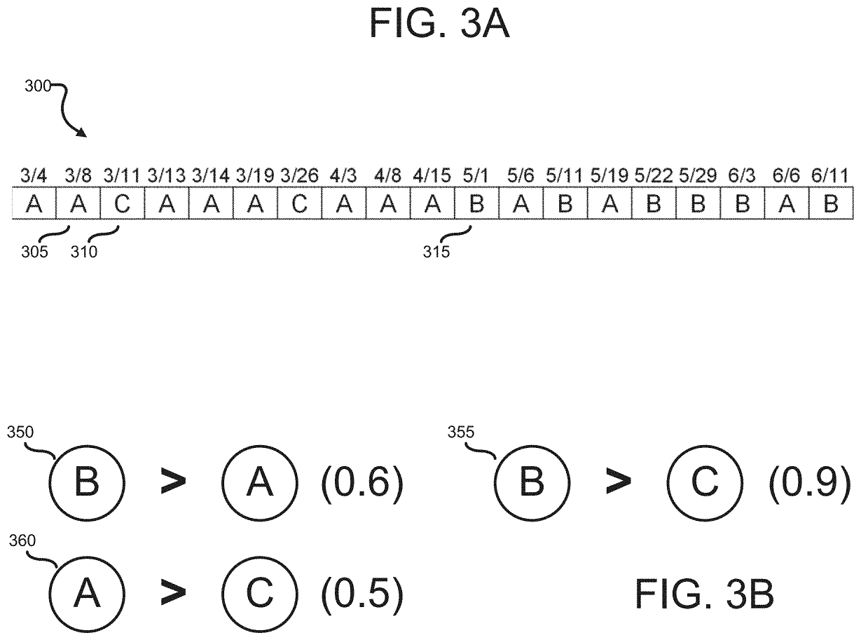

FIG. 3A illustrates an example of a transaction history 300 according to certain embodiments of this disclosure. The embodiment of the transaction history 300 shown in FIG. 3A is for illustration only and other embodiments could be used without departing from the scope of this disclosure.

Referring to the non-limiting example of FIG. 3A, in certain embodiments according to this disclosure, one or more computing platforms (for example, device 100 in FIG. 1 or server 200 in FIG. 2) can generate comparison-based rankings of transaction objects based on one or more stored data sets accessible to the computing platform, wherein the one or more data sets comprise one or more transaction histories. As used in this disclosure, the term “transaction history” encompasses, without limitation, a chronologically (either by date, or time, or both) demarked record of a user's interactions with one or more transaction records. As used in this disclosure, the term “transaction object” encompasses an entity with which a user can choose to interact, and for which a user can form a preference between various transaction objects. Examples of transaction objects include, without limitation, restaurants, web pages, products, media content (for example, movies), user profiles, and geographic locations. While in many of the examples in this disclosure utilize restaurants as transaction objects, this is because restaurants and restaurant categorizations are broadly understood and work well for the explanatory examples presented herein, and should not be interpreted as limiting the scope of the present disclosure.

There is a wide range of sources of data from which users' preferences regarding transaction objects can be inferred, each of which can present its own set tradeoffs between reliability as a source of data to infer user preferences, accessibility and granularity. For example, survey data (e.g., obtaining starred rankings) is readily accessible, in that potentially anyone can register their sentiments towards a transaction object by assigning a star value (for example, five stars out of a possible five) to the transaction object. Such surveys typically present a tradeoff in the granularity of the data obtained (for example, a five star system may only register five possible levels of preference) and potential insensitivity to a particular user's preferences (as reviewers with dissimilar overall tastes may predominate in the reviewer pool).

Experimental data shows that, where rankings between transaction objects are performed based on pairwise comparisons between transaction objects extracted from data sets that comprise transaction histories for users, the accuracy of rankings (for example, the extent to which the rankings actually align with a particular user's interests) are improved, and the computational load of calculating the rankings is reduced, as compared to other approaches for generating rankings of transaction objects. It should be noted that, in certain embodiments according to this disclosure, the data set for determining rankings of transaction objects need not be limited to only the transaction histories of a plurality of users, but can further include, without limitation, demographic, (for example, a user's age or city of residence), social (for example, data showing patterns in a user's activity in online social networks), or financial (for example, quantifications of transactions with transaction objects, such as group size or monetary amount spent) data.

Referring again to the non-limiting example of FIG. 3A, transaction history 300 comprises a series of identifiers (shown as “A,” “B” and “C”) of transaction objects, each of which are associated with dates spanning a period from March 4 to June 11. For convenience of description, in this particular example, transaction objects “A,” “B” and “C” represent restaurants at which a user dined. For example, entry 305 indicates that, on March 8, the user dined at restaurant “A,” while entry 310 indicates that on March 11, the user dined at restaurant “C,” and entry 315 indicates that, on May 1, the user dined at restaurant “B.” As discussed in greater detail in this disclosure, each user's transaction history potentially contains patterns indicating their relative preferences between transaction objects. According to certain embodiments, patterns in each user's transaction history can be recognized and sets of pairwise comparisons between transaction objects can be extracted from data sets that include each user's transaction history.

FIG. 3B illustrates three examples of pairwise comparisons extracted from a transaction history (for example, transaction history 300 in FIG. 3A), according to various embodiments of this disclosure. According to certain embodiments, a pairwise comparison comprises an expression of a preference between a pair of transaction objects. In other words, in some embodiments, a pairwise comparison indicates, for a given user, and a given pair of transaction objects, the relative preference for one transaction object over the other. In some embodiments, a pairwise comparison may also be associated with a confidence interval quantifying a probability that the transaction object identified as being preferred, in fact, preferred over another transaction object.

In the illustrative example of FIG. 3B, three pairwise comparisons (350, 355 and 360) are shown. According to certain embodiments, a first pairwise comparison 350 indicates that, for the user with transaction history 300 in FIG. 3A, a restaurant associated with transaction object “B” has been determined to be preferred over a restaurant associated with transaction object “A.” Further, as shown by the (0.6) confidence interval, in this example, the calculated probability that the user prefers the restaurant associated with transaction object “B” over transaction object “A” is sixty percent. Similarly, second pairwise comparison 355 indicates that the restaurant associated with transaction object “B” has been determined to be preferred by this user over the restaurant associated with transaction object “C,” and that the probability that the user actually prefers restaurant “B” over restaurant “C” has been calculated at 90 percent. Finally, third pairwise comparison “C” indicates that the restaurant associated with transaction object “A” is preferred by the user over the restaurant associated with transaction object “C.” Further, the 0.5 confidence interval indicates that the calculated percentage that the user actually prefers restaurant “A” over restaurant “C” is 50%, meaning that there is a low degree of confidence that the user truly prefers restaurant “A” over restaurant “C.

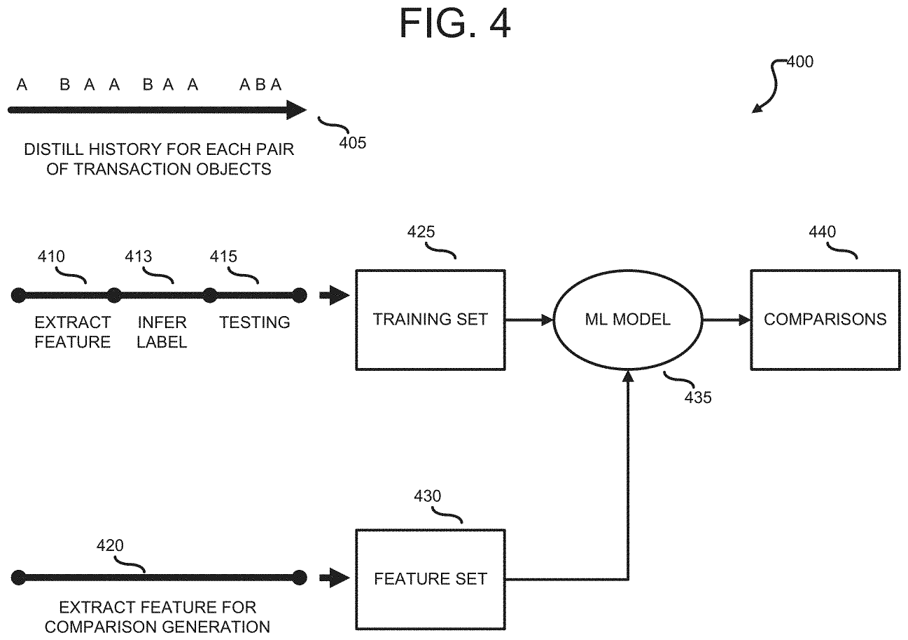

FIG. 4 illustrates an example of a method 400 for extracting pairwise comparisons from a transaction history, according to various embodiments of this disclosure. While the flow chart depicts a series of steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by processor circuitry in, for example, a mobile terminal or computing platform.

Recalling the non-limiting examples of FIGS. 3A and 3B, certain embodiments according to this disclosure determine rankings of transaction objects based on, at least in part, pairwise comparisons between transaction objects. Further, as noted with respect to the illustrative examples of FIGS. 3A and 3B, in certain embodiments, pairwise comparisons are extracted from a data set based on recognized patterns in the data set. Skilled artisans will appreciate that, for a given transaction history, there may be a plurality of patterns to be recognized and techniques for pattern recognition, which can be applied to the transaction history. For example, a frequency-type analysis could be applied, comprising a comparison of the relative frequency with which a user visited restaurants “A,” “B” and “C.” By such an approach, restaurant “A,” with which the user conducted eleven transactions, would be determined to be preferable over restaurant “B,” at which the user only dined on six occasions during the sample period of transaction history 300. While computationally simple, such frequency-based analyses can miss shifts in preference, or points of inflection within the transaction history. For example, in transaction history 300 in FIG. 3, starting May 1, the user's visits to restaurant “C” cease, and she begins visiting restaurant “B” regularly. As noted above, a frequency, or counting based analysis over a rolling three-month interval would take approximately 1-2 months to note this apparent shift in the user's current preferences. Thus, rankings drawn on pairwise comparisons extracted by a frequency analysis of a transaction history could be inaccurate, as lagging behind the user's current preferences.

As a further example of another analysis that could be applied to transaction history 300 to generate pairwise comparisons, an Elo analysis, such as used for calculating chess player rankings may be used. However, such analyses are subject to overweighting of the most recent event, which can result in unstable rankings of transaction objects. Such instability in rankings can be, at a minimum, undesirable from a user perspective, in that they appear as inconsistent recommendations.

Certain embodiments according to this disclosure utilize machine learning (ML) techniques to extract pairwise comparisons from transaction data. Additionally, some embodiments according to this disclosure generate groups of users based on first (and in some embodiments, second and further-level) features, and apply a gravity ranking algorithm to sets of pairwise comparisons to generate rankings of transaction objects. According to certain embodiments, the above-described three-stage approach yields good performance along multiple dimensions of performance of recommendation and ranking, including, without limitation, stability of results, sensitivity to shifts in user preferences, computational load, and the ability to “tune” the degree of personalization in a ranked set across different user groups.

Referring to the non-limiting example of FIG. 4, method 400 for extracting pairwise comparisons comprises a multi-stage process of training a machine learning model 435 to output, based on recognized features in each user's transaction history, pairwise comparisons (for example, first pairwise comparison 350 in FIG. 3B) indicating, for a pair of transaction objects, which transaction object is preferred by the user, and a confidence score associated with the determination of the preferred transaction object. For convenience of cross reference and to assist in explanation, the example described with reference to FIG. 4 uses transaction history 300 shown in FIG. 3A.

Referring to the non-limiting example of FIG. 4, the process for extracting pairwise comparisons from transaction history 300 begins with operation 405, wherein for a user (and, when iterating method 400 across a plurality of users in a data set), the transaction history is distilled into a history for each pair of transaction objects within the transaction history. Thus, in the non-limiting example of FIG. 4 and transaction history 300, at operation 405, there are three distinct pairs of transaction objects (A-B, A-C and B-C), and as such, three histories are distilled at operation 405. While not shown in this example, in certain embodiments, to save computational resources, some of the histories obtained at 405 may be discarded, on the grounds that the transaction categories belong to non-analogous categories (for example, where a first transaction object is a car wash, and a second transaction object is a restaurant). In such cases, the history of a non-analogous pair of transaction objects requires no further processing.

According to certain embodiments, for each history obtained at operation 405, the time period covered by the history is divided into three non-overlapping stages comprising a feature extraction stage 410, a label generation stage 413 and a testing stage 415. According to certain embodiments, during the feature extraction, for each qualifying history obtained at operation 405, features from which patterns that can be labeled are identified. Examples of features that are extracted during feature extraction stage 410 include, without limitation, a transaction count ratio during a feature extraction stage, a transaction count ratio after both transaction objects appeared during the feature extraction stage, a transaction count ratio between the pair of transaction objects during a first predetermined interval (for example, one month) before the end of the feature extraction stage, a transaction count ratio between transaction objects over second and third predetermined intervals (for example, two months and three months) before the end of the feature extraction stage, or a transaction count between transaction objects over a sub-interval (for example, a particular month within the feature extraction stage). Depending on embodiments, additional features are possible and may be extracted during feature extraction stage 410.

According to certain embodiments, during label generation stage 413, for each qualifying history (for example, excluding histories between pairs of incomparable transaction objects) obtained at operation 405, labels are assigned between the pair of transaction objects. As used herein, the term “label” encompasses an indication as to which transaction object of a pair of transaction objects is preferred.

Referring to the non-limiting example of FIG. 4, during testing stage 415, the labels generated during label generation stage 413 are tested against data within the history to the predictiveness of the generated labels. According to various embodiments, the features extracted during feature extraction stage 410, the labels generated during label generation stage 413, and the data obtained during testing stage 415 collectively comprise training set 425, which is used to train ML model 435. According to various embodiments, ML model 435 is a classification-type ML model, and can be, without limitation, a random forest model, a decision model, a gradient-boosted tree model or a naive Bayes model.

In some embodiments according to this disclosure, once training set 425 has been generated and ML model 435 has been trained with training set 425, at operation 420, the trained model can perform feature extraction for generating pairwise comparisons across the transaction history (for example, transaction history 300 in FIG. 3A), to generate a feature set 430. According to various embodiments, operation 420 can be performed over the relevant distilled histories obtained at operation 405, or across the entire transaction history at once. As shown in the non-limiting example of FIG. 4, feature set 430 is provided to trained ML model 435, which outputs a set of pairwise comparisons 440, wherein each pairwise comparison comprises an indication of the preferred member of the compared pair, as well as a confidence score for the comparison.

While not shown in the example of FIG. 4, according to certain embodiments, subsequent to outputting set of pairwise comparisons 440, the outputted pairwise comparisons are incorporated into a graph. In some embodiments, comparison compression operations to reduce and refine the set of outputted pairwise comparisons by removing weak or redundant edges from the graph may be performed. For example, in certain embodiments, comparison compression includes applying one or more graph algorithms to remove edges redundant edges. For example, edges associated with comparisons that could be transitively inferred, such as A>C, where A>B and B>C, can be removed, to reduce the size of the set of pairwise comparisons, thereby reducing the computational load associated with generating rankings of transaction objects drawn from pairwise comparisons extracted from the data of a large group of users. According to certain embodiments, comparison compression operations further comprise removing “weak edges” (for example, comparisons with confidence intervals below a threshold value), as well as low-credibility edges. As a non-limiting example of a low credibility edge, consider the case where a set of pairwise comparisons 440 includes the following comparisons: A>B, B>C and C>A. Logically, this “circle of preferences” is impossible, and at least one of the three edges is not credible. According to some embodiments, the least credible edge can be identified and removed from the graph.

While in the illustrative example of FIG. 4, method 400 is described with regard to obtaining pairwise comparisons from a single user's transaction history across a single time period, embodiments according to this disclosure are not limited thereto. Rather, in some embodiments, method 400 can be performed for each user for which a data set accessible to the computing platform (for example, server 200 in FIG. 2) performing method 400. Additionally, for a given user, method 400 may be reiterated, in order to update a set of pairwise comparisons between transaction objects for the user. According to some embodiments, by iterating method 400 over transaction histories for all the users, (including users belonging to certain user groups) in a data set, a corpus of pairwise comparisons associated with a transaction object can be generated.

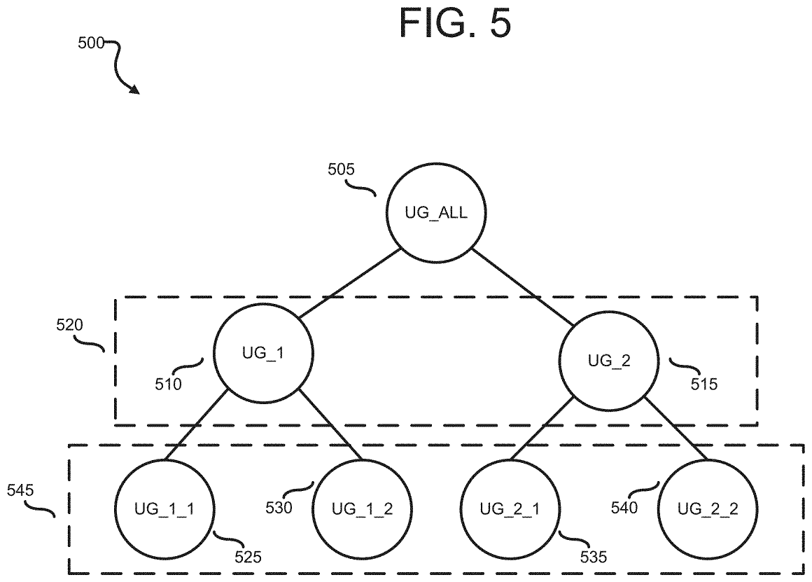

FIG. 5 illustrates an example of a hierarchy 500 among user groups generated according to certain embodiments of this disclosure. The embodiment of the hierarchy 500 shown in FIG. 5 is for illustration only and other embodiments could be used without departing from the scope of this disclosure.

According to certain embodiments, the quality of rankings and recommendations provided to a user can be enhanced by providing rankings of transaction objects, which can be tuned to patterns within a group of users similar to a user seeking rankings among transaction objects. By way of a simple, non-limiting explanatory example, imagine a user “A,” for whom an analysis of her transaction data indicates that her favorite cuisine is Korean food, and that she regularly eats at restaurants serving Korean food. User “A” seeks from a computing platform generating rankings of transaction objects, a ranking of preferred Korean restaurants satisfying one or more search criteria (for example, proximity to her current location). According to some embodiments, the data from which rankings are determined includes data regarding Korean restaurants collected from users who prefer cuisines other than Korean food and who only occasionally eat at Korean restaurants. To the extent the general pool of users may prefer other cuisines; rankings of Korean restaurants generated from their transaction histories may not be helpful to users such as user “A.” In simple terms, the preferences of another user who is singularly passionate about German food are unlikely to provide useful recommendations for Korean restaurants for user “A.” Instead, rankings drawn from the transaction histories of users whose data history shows a similar macro-level preference (i.e., for Korean restaurants) may be significantly more helpful to user “A.” Certain embodiments according to this disclosure facilitate the provision of helpful like-to-like user recommendations by generating user groups.

Referring to the non-limiting example of FIG. 5, an example of a hierarchy 500 among a set of users from whose transaction histories pairwise preferences have been extracted (for example, by method 400 shown in FIG. 4) is shown in the figure. At the top of hierarchy is the user group 505, comprising a superset of users from whose pairwise comparisons between transaction objects have been extracted from their transaction histories. According to some embodiments, user group 505 comprises all users from whom one or more pairwise comparisons have been extracted. In some embodiments, user group 505 comprises a subset of the total universe of users known to the system (for example, server 200 in FIG. 2) whose transaction histories satisfy one or more relevance criterial (for example, number of transactions within a recent time period, or, for transaction objects where purchases are made, a threshold monetary value of the purchases).

According to certain embodiments, within hierarchy 500, there are user groups comprising two or more subsets (for example, UG_1 510 and UG_2 515 in FIG. 5) of top-level user group 505, wherein each subset of the top-level group comprises a set of users whose transaction histories exhibit commonalities or other identifiable patterns in the first level features 520 in the population of transaction objects in the transaction histories of users in the user groups.

By way of a simple, non-limiting example—consider a data set in which all the transaction objects are merchants at which users have purchased goods or services. General merchant categories (for example, entertainment, restaurant, skilled trades, etc.) are, in some embodiments, a first level feature of merchants. By analyzing first level features and patterns in the first level features within users' transaction histories, groups of analytically usefully analogous can be identified. For example, users whose transaction histories show a recognized pattern of transaction objects associated with food and entertainment may be more likely to have similar preferences than users whose transaction histories show a recognized pattern of transaction objects associated with home improvement and child care.

According to certain embodiments, a user can belong to multiple user groups, and it is possible to generate further user groups within a larger user group based on second and higher-level features. For example, in the example of FIG. 5, user group “UG_1” 510 and user group “UG_2” 515 further subdivide into user groups “UG_1_1” 525, “UG_1_2” 530, “UG_2_1” 535 and “UG_2_2” 540, according to identified commonalities or patterns among second level features of transaction objects within the user groups' transaction histories.

By way of non-limiting example, suppose that user group “UG_1” 510 comprises a collection of users, the first level features of transaction objects in whose transaction histories show a common pattern of an emphasis on food and entertainment. Restaurant genre and merchant subcategories categories may, in certain embodiments, comprise second-level features among transaction objects. Thus, user group “UG_1_1” 525 may comprise, for example, a subset of user group “UG_1” 510 whose transaction histories show a recognized pattern of visits to transaction objects having the second-level feature of being categorized as “movie theatres.” Similarly, user group “UG_1_2” may comprise a subset of user group “UG_1” 510 whose transaction histories show a recognized pattern of transactions with transaction objects associated with the second-level feature of being in the category of “Asian restaurants.”

According to certain embodiments, the user groups of hierarchy 500 can be generated using data science methodologies and, in particular, clustering algorithms. As one non-limiting example, user groups of a hierarchy of users whose transaction histories comprise data associated with interactions (e.g., visits and purchases) with transaction objects that are merchants can be generated as follows.

As an initial step, all users whose transaction histories fail to satisfy one or more predetermined validity criteria are analyzed. As one illustrative example, users who do not make a threshold number of purchases or who fail to meet a spending threshold may be excluded from the superset of all users. Next, for the remaining users, their spending in each merchant category of a predefined set of first-level merchant categories can be accumulated, and an L2 normalization of their spending in each category, resulting in a ratio set of the user's spending in each first level category. Next, in some embodiments, the users for which a ratio set of their spending by first level category has been generated are clustered (for example, using a K-means algorithm) to generate a set of first level user groups. According to various embodiments, the number of clusters of users comprising first level user groups is selected by balancing two or more of the following factors: (1) the coverage of major features (for example, top-level merchant categories); (2) similarities between user groups (for example, as measured by L1 or L2 norm); and (3) the entropy of user distributions and sizes of subsequently generated sub-groups. According to various embodiments, the above-described process of normalization and clustering is reiterated for second and higher-level features, in order to create sub-user groups, sub-sub-user groups and so on.

While, in the non-limiting example of FIG. 5, hierarchy 500 has been described with reference to user groups determined based on a transactional dimension (i.e., according to recognized patterns among transaction objects in users' transaction histories), embodiments according to this disclosure are not limited thereto. According to some embodiments, the composition of user groups can variously be defined or refined using other sources of data, including without limitation, demographic or social data. Depending on the nature of transaction object (for example, very expensive, infrequently conducted transactions) demographic or social data (for example, annual household income) may prove useful in generating a set of users whose preferences can provide meaningful rankings between transaction objects.

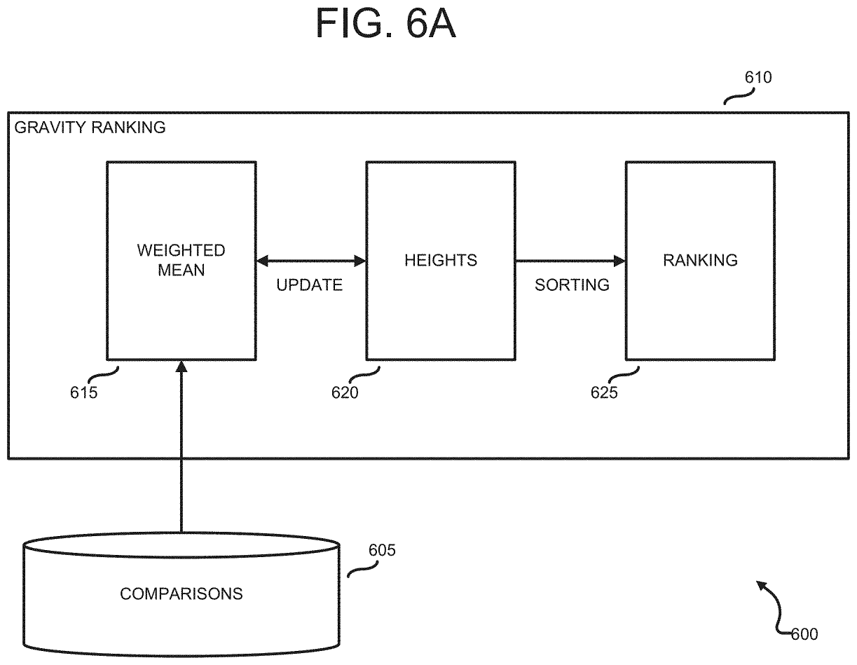

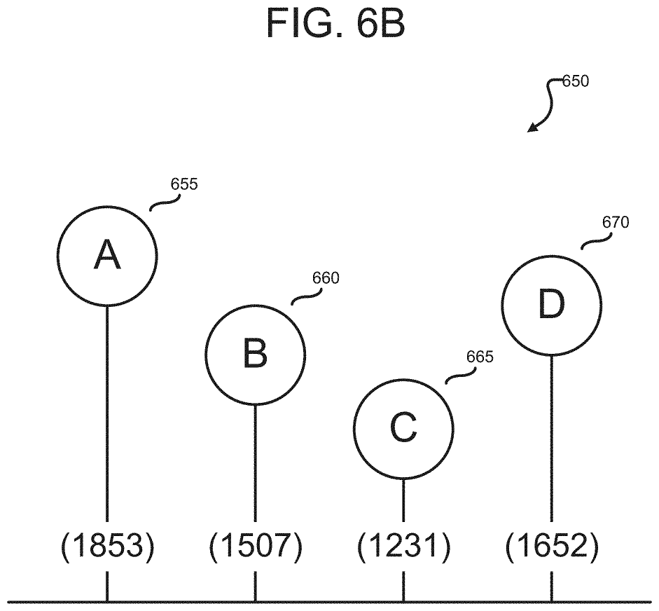

FIG. 6A illustrates an example of a logical architecture 600 for implementing a gravity ranking algorithm for generating rankings between transaction objects based on pairwise comparisons according to various embodiments of this disclosure. FIG. 6B illustrates an example of a set of heights 650 for transaction objects determined using logical architecture 600. The embodiments of the logical architecture 600 and set of heights 650 shown in FIGS. 6A and 6B are for illustration only and other examples could be used without departing from the scope of the present disclosure.

As noted elsewhere herein, testing has shown that implementing a gravity ranking algorithm according to certain embodiments of this disclosure to determine rankings between transaction objects provides a number of performance benefits, including without limitation, avoiding overweighting new transaction objects, avoiding arbitrarily lowering the ranking of a longstanding transaction object due to a large population of rankings, providing a desirable level of stability within rankings, and the ability to tune the particularity of rankings based on user groups.

At a basic level, gravity ranking algorithms according to certain embodiments of this disclosure operate by determining, for each transaction object, a present height for the transaction object. According to certain embodiments, each pairwise comparison that satisfies certain criteria discussed herein becomes associated with an upward force vector on the preferred transaction object and a downward force vector on the disfavored transaction object. For each transaction object, a new height is calculated based on the weighted mean of the vectors associated with the transaction object. This process is reiterated until the heights of the transaction objects stabilize, resulting in a present set of heights for transaction objects (for example, set of heights 650 in FIG. 6B).

According to certain embodiments, rankings of transaction objects according to their present height can be determined. Further, the rankings of transaction objects can be made more or less specific to a particular user's preferences by switching user groups, and providing rankings of transaction objects which appear in the transaction histories (or in the recent transaction histories) of users within a user group. For example, returning to the case of the hypothetical user “A” discussed with reference to FIG. 5 of this disclosure, user “A” may, in addition to the top-level user group, belong to a sub-group of users whose transaction histories comprise a recognized pattern of transaction objects associated with the first level feature of being categorized as “restaurants.” Further, user “A” may belong to a sub-sub-group of users whose transaction histories comprise a recognized pattern of transaction objects associated with the second level feature of being categorized as “Korean restaurants.” Further, the established Korean restaurant “X” has been determined by a gravity ranking algorithm to have the highest present height, while the newly opened Korean restaurant “Y” has a lower present height. For rankings drawn among users in the above-described top-level group, and sub-group, restaurant “X” may occupy the top ranking among Korean restaurants. However, in the event of an interest shift amongst enthusiastic patrons of Korean restaurants from restaurant “X” to restaurant “Y,” restaurant “Y” may occupy the top spot in a ranking drawn among users within the sub-sub-group to reflect the interest shift towards restaurant “Y.” By providing rankings across a plurality of user groups, the effectiveness of computing platforms as tools for obtaining meaningfully ranked sets of transaction objects is enhanced, in that the specificity of personalization becomes tunable. For example, user “A” could, if desired, select a high-level user group to find the highest ranked Korean restaurant for a group with heterogeneous dining preferences, and then switch to a lower-level user group to find the highest ranked Korean restaurant with her family, who have similar dining preferences and experience with the set of transaction objects comprising Korean restaurants in the area.

Referring to the non-limiting example of FIG. 6A, logical architecture 600 comprises a stored set of pairwise comparisons 605 (for example, pairwise comparisons obtained by applying method 400 in FIG. 4) between transaction objects. According to some embodiments, set of pairwise comparisons 605 is stored in a memory of the computing platform implementing gravity ranking algorithm 610 (for example, memory 160 in FIG. 1, or persistent storage 235 in FIG. 2). In certain embodiments, stored set of pairwise comparisons 605 is maintained one or more separate platforms, such as a cloud computing platform. In some embodiments, the pairwise comparisons of stored set of pairwise comparisons comprise both an indication of the preferred transaction of a comparison between a pair of comparison objects and a confidence score associated with the indication of the preferred transaction object. In some embodiments, confidence scores may only be used for comparison compression and removing problematic edges, and only the indications of preferred transaction objects are maintained as stored set of pairwise comparisons 605.

As shown in the illustrative example of FIG. 6A, stored set of pairwise comparisons 605 is provided to a computing platform or computing platforms (for example, device 100 in FIG. 1 or server 200 in FIG. 2) implementing gravity ranking algorithm 610. According to certain embodiments, gravity ranking algorithm 610 comprises three main processing stages, a weighted mean determination stage 615, a present height recording stage 620, and a ranking stage 625.

According to certain embodiments, weighted mean determination stage 615 generates, for each transaction object for which a height is to be calculated, a set of force vectors acting upon the object, and then calculates a new height for the transaction object based on a weighted mean of the force vectors acting upon the transaction object. Each force vector is calculated based on a pairwise comparison taken from stored set of pairwise comparisons 605. In some embodiments, the force vectors acting upon a pair of transaction objects in a pairwise comparison are calculated as described below.

Initially, the height for each transaction object is set to zero (0). Referring to the non-limiting example of FIG. 6B, in the figure, transaction objects 655, 660, 665 and 670, are shown as having various heights (for example, first transaction object 655 has a height of 1853). Initially, each of these transaction objects has a starting height of 0. From this initial state, multiple rounds of force vector based height calculations based on the available pairwise comparisons (for example, pairwise comparisons obtained from set of pairwise comparisons 605) of the transaction objects are performed until the heights of the transaction objects achieve a stability criterion (for example, a maximum amount of change over calculation rounds).

In each calculation round, for each pairwise comparison between a first object and a second object, an initial comparison of the height difference between the preferred and disfavored transaction objects is performed to determine to which one of the following two categories the height differential between the transaction objects belongs. A first category of height differential occurs when the present height of the preferred transaction object is greater than the present height of the disfavored transaction object plus a constant gap (referred to herein as a “Premium”). When the height differential between the preferred object and the disfavored object is determined to be large enough to belong to this no further action (i.e., no force vectors) is taken on this pairwise comparison.

In some embodiments, a second category of height differential occurs when the present height of the preferred transaction object is less than the present height of the disfavored object plus the premium. In this case, the height differential is such that the pairwise comparison between the preferred and disfavored transaction objects is analytically meaningful, and an upward force vector for the preferred transaction object is determined, and a downward force vector for the disfavored object is also determined. According to certain embodiments, the upward force vector for the preferred transaction object is calculated as: Tᵢ*Wᵢ. Where “Wᵢ” is a weight assigned to the comparison, and Tᵢ is a target height, expressed in this case as: ((present height of disfavored transaction object)+Premium).

In some embodiments, the downward force vector to be applied to the disfavored transaction object is calculated as: Tᵢ*Wᵢ. In this case, target height Tᵢ is expressed as: ((present height of preferred transaction object)+Premium)

According to some embodiments, weight “Wᵢ” may be held constant across all force vectors calculated for a transaction object. In some embodiments, the value of weight “Wᵢ” can be conditionally adjusted, for example, by assigning greater weights to comparisons made within a user group of interest. For example, the performance of the system (as measured, for example, by the relevance of the rankings to users' current preferences) can be enhanced by “pushing down” the height of transaction objects for which there are few total, or, in certain embodiments, few recent pairwise comparisons. As discussed above, for each transaction object, for which a force vector has been generated, each force vector has a weight Wᵢ. For a given object, the weight of the transaction object itself can be expressed as sum of the weights of the force vectors, or ΣWᵢ.

In the case in which the weight of the transaction object is low and falls below a threshold value MIN_REQUIRE (i.e., there are relatively few total, or relatively few pairwise comparisons), the transaction object can be demoted, as if it were being pulled downwards by a virtual object having height zero. In such cases, the force vector pulling the transaction object towards height zero has weight:

W=(MIN_REQUIRE−ΣWᵢ).

According to certain embodiments, after all of the pairwise comparisons affecting the present height of a transaction object have been considered, the updated present height of the transaction object is recalculated as:

$$\frac{\sum {T}_{i} \times {W}_{i}}{\sum {W}_{i}}$$

In some embodiments, the present height for each transaction object is calculated according to the above steps, and the present heights of the transaction objects are stored in present height storage stage 620, thereby completing a first round of height calculation. Second and further rounds of height calculation, using the previously calculated heights for the transaction objects (rather than initial height zero) are performed until the present heights satisfy one or more predefined stability criteria (for example, a change round-to-round change value under a threshold amount. According to certain embodiments, a set of present heights for the transaction objects (for example set of heights 650 in FIG. 6B) is stored in present height storage stage 620.

Referring to the explanatory example of FIG. 6A, in certain embodiments, ranking stage 625 sorts the present heights stored in present height storage stage 620 to generate sets of rankings between transaction objects. According to various embodiments, ranking stage 620 creates an overall ranking of the present heights in present height storage stage 620, and filters the heights across one or more parameters, including, without limitation, first, second and higher level categories associated with transaction objects, as well as transaction objects with which members of a specified user group have transacted with, or recently transacted with. According to certain embodiments, ranking stage 625 generates data objects, the data objects comprising rankings in response to requests received from another computing platform (for example, a search application operating on a mobile terminal) which is communicatively connected to the computing platform (for example, server 200 in FIG. 2) implementing gravity ranking algorithm 610.

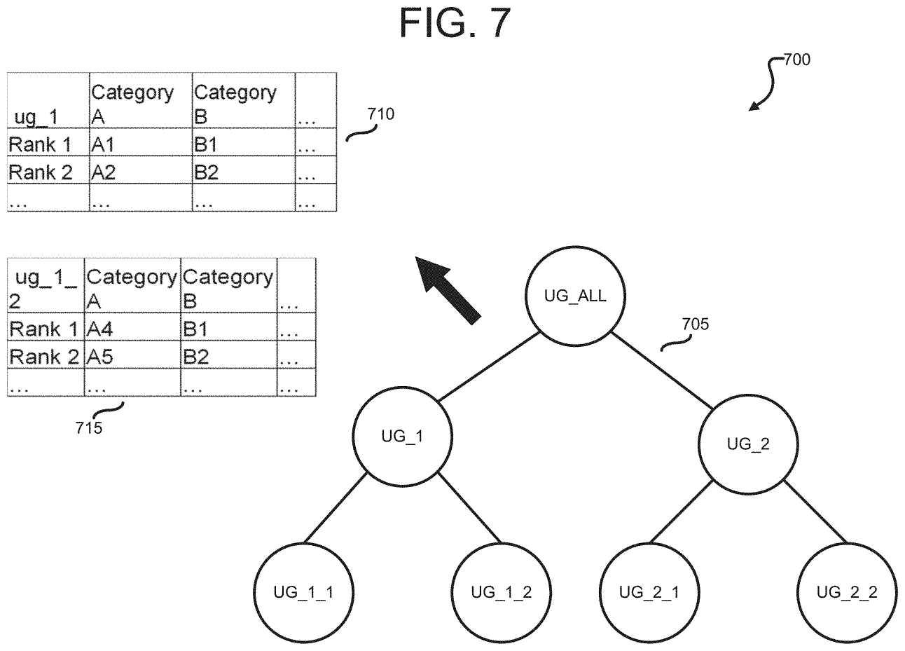

FIG. 7 illustrates an example 700 of a ranking of transaction objects across user groups output by certain embodiments of this disclosure. The example 700 shown in FIG. 7 is for illustration only and other examples could be used without departing from the scope of the present disclosure.

As noted elsewhere in this disclosure, certain embodiments according to this disclosure determine groups of users within a data set who exhibit, for example, through clustering of their interactions with transaction objects, or through other user data (for example, age or income data) similarities pointing to an increased probability of shared preferences between transaction objects. According to certain embodiments, by creating hierarchical user groups within a top-level user group (for example, “UG_ALL” in FIG. 7), and providing rankings of transaction objects (for example, rankings output by gravity ranking algorithm 610 in FIG. 6A, it is possible to not only provide highly personalized rankings, but also, to scale back the level of personalization to provide rankings more appropriate for general groups of users.

Referring to the non-limiting example of FIG. 7, according to certain embodiments, a hierarchy 705 is generated for a set of users having transaction histories showing interactions (for example, purchases or visits) with a set of transaction objects. According to certain embodiments, hierarchy 705 divides and sub-divides and clusters users into user groups based on recognized patterns in first, second, and higher level features among transaction objects with which they interact (for example, by generating a hierarchy 500 according to the methods discussed with reference to the example of FIG. 5 of this disclosure).

According to certain embodiments, user groups have a transactional component, in that members of a user group may only transact (or transact recently) with only a subset of the transaction objects belonging to a category of transaction objects. By filtering a ranking of transaction objects across the transaction objects with which members of a user group have transacted (or transacted with in a way satisfying threshold criteria, for example, recency or total number of transactions), user-group specific rankings can be generated. For example, in FIG. 7, for the first level user group 1, by mapping the rankings of transaction objects belonging to categories “A” and “B” across first level user group UG_1, a first set of rankings 710, specific to user group UG_1 is determined. In this explanatory example, within category “A,” transaction object A1 is ranked first and transaction object A2 is ranked second. While not shown in the figure, additional categories and additional rankings within each category can be shown.

Further, as shown in the explanatory example of FIG. 7, a second set of rankings 720, specific to the sub-group UG_1_1 is determined. In this explanatory example, within category “A,” transaction object A4 is ranked first and transaction object A5 is ranked second in this set of rankings mapped to the smaller user group UG_1_2. In this way, by providing the options of generating rankings across user groups with more or less focus in their preferences, certain embodiments according to this disclosure can readily detect interest shifts (for example, a shift among regular patrons of Korean restaurants from Korean restaurant “1” to Korean restaurant “2”) among sets of users with particular interests. At the same time, the option of providing rankings across higher or even top-level user groups means that embodiments according to this disclosure can provide rankings appropriate for user groups with generalized interests.

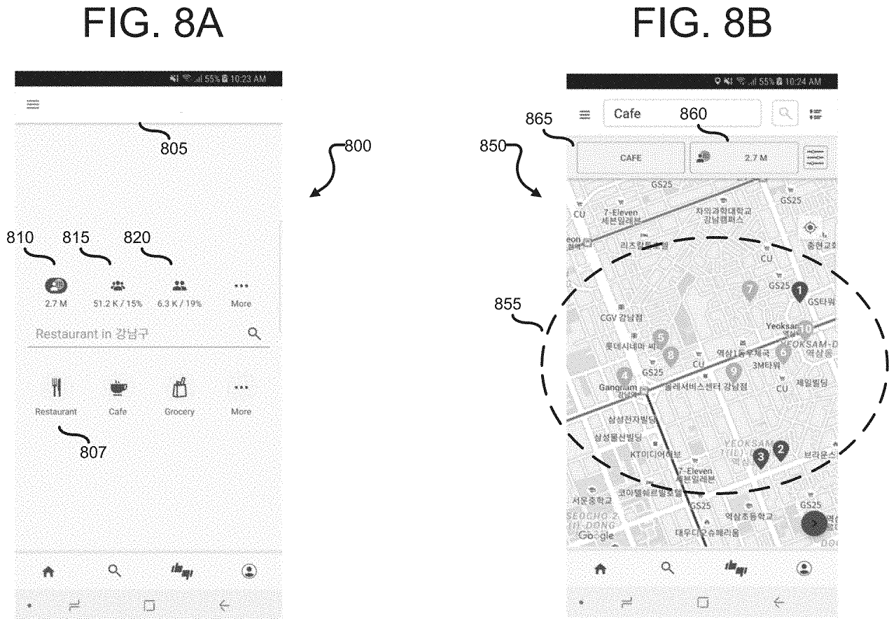

FIGS. 8A and 8B illustrate two examples of user interfaces of an application provided at an electronic device (for example, device 100 in FIG. 1) for providing user group-mapped rankings of transaction objects according to various embodiments of this disclosure. The examples of the user interfaces shown in FIGS. 8A and 8B are for illustration only and other examples of user interfaces could be used without departing from the scope of the present disclosure.

Referring to the non-limiting example of FIG. 8A, an example of a first user interface 800 of an application for obtaining user group-mapped rankings of transaction objects is shown in the figure. According to certain embodiments, the application providing first user interface is a navigation program with a search functionality, such as a “Maps” application on a smartphone, through which a user can enter descriptors of a transaction object (for example, “Bank” or “Mexican restaurant”) and obtain a set of geographically proximate results ranked according to relevance.

According to certain embodiments, first user interface 800 allows users to define parameters of a request for a ranked set of transaction objects and submit same to an algorithm (for example gravity ranking algorithm 610 in FIG. 6A) operating on the device or, via a network, to a separate computing platform (for example, server 200 in FIG. 2). As shown in the illustrative example of FIG. 8A, first user interface 800 comprises a search bar 805, through which a user can enter textual search terms. According to various embodiments, first user interface 800 further comprises one or more buttons (for example, button 807, which is associated with restaurants) to quickly select suggested search categories. Further according to some embodiments, first user interface 800 comprises first, second, and/or third buttons 810, 815 and 820 for selecting a user group to which the rankings are to be mapped. For example, first button 810 allows the user to map the rankings of transaction objects in the search results to a larger (or more general) user group, while second button 815, allows the user to map the rankings of transaction objects in the search results to a middle-sized (or moderately personalized) user group, and third button 820 allows the user to map the rankings of transaction objects in the search results to an even smaller (or more personalized) user group.

FIG. 8B illustrates an example of a second user interface 850 of the application for obtaining user group-mapped rankings of transaction objects according to various embodiments of this disclosure. A second user interface 850 is provided by the application in response to a request for user group-mapped rankings of transaction objects through first user interface 800 described with reference to FIG. 8A. According to certain embodiments, second user interface 850 comprises a ranked set of transaction objects 855, which in this particular example, are shown as pins on a map of Seoul, with each pin showing a relevance ranking. As shown in the illustrative example of FIG. 8B, second user interface 850 further comprises a first indicator 865 of the search term, and a second indicator 860 of the user group to which the ranked set of transaction objects identified by the search was mapped. In this example, the ten transaction objects 855 shown on the map are shown as being mapped to the user group having 2.7 million members.

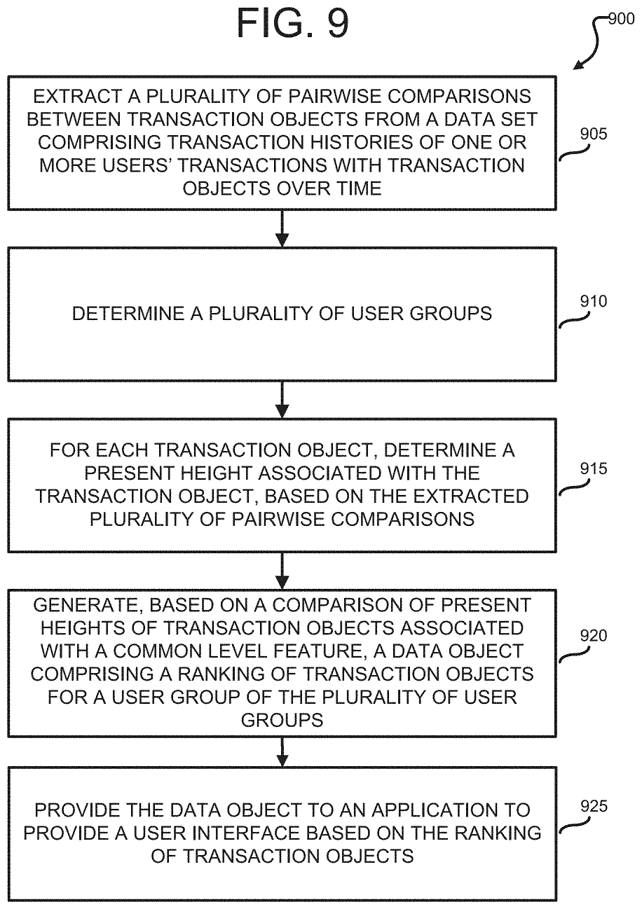

FIG. 9 illustrates an example of operations of a method 900 for obtaining a ranking of transaction objects from a data set comprising transaction histories of one or more users' transactions, according to various embodiments of this disclosure. While the flow chart depicts a series of steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by processor circuitry in, for example, a mobile terminal or computing platform.

Referring to the non-limiting example of FIG. 9, according to some embodiments, method 900 comprises operation 905, wherein one or more computing platforms (for example, device 100 in FIG. 1 or server 200 in FIG. 2) extract a plurality of pairwise comparisons (for example, pairwise comparisons 350, 355 and 360 in FIG. 3B) between transaction objects, from one or more users' transaction histories (for example, transaction history 300 in FIG. 3A). According to certain embodiments, the pairwise comparisons are obtained by applying an ML method (for example, method 400 in FIG. 4) utilizing a model trained upon one or more transaction histories in the data set.

As shown in the illustrative example of FIG. 9, at operation 910, a plurality of user groups is determined. According to various embodiments, the determined user groups belong to a hierarchy (for example, hierarchy 500 in FIG. 5) comprising a top-level user group (for example “UG_ALL” in FIG. 5), and sub-groups, sub-sub-groups, and further groups associated with patterns among first, second and higher-level features among transaction objects in the users' transaction histories. In some embodiments, the user groups are determined on a combination of transactional and other (for example, demographic or social data) to enhance the analytical meaningfulness of the user groups.

According to some embodiments, at operation 915, for each transaction object, a present height associated with the transaction object is determined based on the extracted plurality of pairwise comparisons. For example, the present height associated with each transaction object may be determined by implementing an architecture for a gravity ranking algorithm (for example, logical architecture 600 in FIG. 6A). According to some embodiments, the present height of each transaction object is determined by calculating (and as necessary, recalculating) a weighted mean of force vectors acting upon the transaction object, wherein the force vectors are determined from the extracted pairwise comparisons.

Referring to the non-limiting example of FIG. 9, at operation 920, a data object based on a comparison of the present heights of transaction objects associated with a common level feature. According to certain embodiments, the data object comprises a file or other data object comprising a ranking of transaction objects for a user group (for example, user group “UG_1” in FIG. 7, or ranked set of transaction objects 855 in FIG. 8B) of the plurality of user groups is determined based on a comparison of present heights of transaction objects associated with a common feature (for example, “Category A” in FIG. 7.

As shown in the illustrative example of FIG. 9, at operation 625, the data object is provided to an application (for example, the application with reference to FIGS. 8A and 8B of this disclosure, to provide a user interface (for example, user interface 850 in FIG. 8B) based on the ranking of transaction objects (for example, ranked set of transaction objects 855) shown on the map in user interface 850.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method of providing a comparison-based ranked output, the method comprising:
at an apparatus comprising a processor and a non-transitory memory, extracting a plurality of pairwise comparisons between transaction objects, from a data set stored in the non-transitory memory, the data set comprising transaction histories of one or more users' transactions with transaction objects over time;
from the stored data set, determining a plurality of user groups, wherein each user group of the plurality of user groups is associated with a common level feature among a set of transaction objects;
for each transaction object, determining a present height associated with the transaction object based on the extracted plurality of pairwise comparisons;
generating, based on a comparison of present heights of transaction objects associated with the common level feature, a data object comprising a ranking of transaction objects for a user group of the plurality of user groups; and
providing the data object to an application to provide a user interface based on the ranking of transaction objects.

2. The method of claim 1, further comprising:
receiving, by the apparatus, over a network from a first electronic device, a request for one or more rankings of transition objects, the request comprising information of a first user;
determining, based on the information of a first user, one or more user groups to which the first user belongs; and
sending, over the network to the first electronic device, a ranking of transaction objects for a user group to which the first user is determined to belong.

3. The method of claim 2, wherein transaction objects of the ranking of transaction objects for the user group to which the first user is determined to belong comprise locations within a predetermined radius of the first electronic device.

4. The method of claim 1, wherein extracting the plurality of pairwise comparisons comprises:
identifying, in the user's transaction history, one or more qualifying pairs of transaction objects;
for each identified pair of transaction objects, extracting features from the user's transaction history;
training a classification model based on the extracted features; and
obtaining, from the classification model, for each pair of transaction objects, a pairwise comparison, the pairwise comparison comprising an indication of which element of the pair of transaction objects is preferred, and a confidence score associated with the indication.

5. The method of claim 4, wherein the extracted features comprise one or more of a transaction count ratio during a feature extraction stage, a transaction count ratio during an interval after two predetermined transaction objects appear in the transaction history, a transaction count ratio between a pair of transaction objects during a predetermined portion of the transaction history, or a transaction count of one or more transaction objects in the transaction history.

6. The method of claim 1, wherein determining the present height associated with the transaction object comprises:
for each pairwise comparison involving the transaction object, determining a force vector for the transaction object; and
adjusting the present height of the transaction object based on a weighted mean of the determined force vectors for the transaction object.

7. The method of claim 6, further comprising:
for each pairwise comparison involving the transaction object and a comparison object, determine a differential between the present height of the transaction object and a present height of the comparison object; and
when the differential is less than a threshold value, determining the force vector for the transaction object based on a product of a premium-adjusted height difference between the present height of the transaction object and the present height of the comparison object and a weight.

8. An apparatus, comprising:
a processor; and
a memory containing instructions, which, when executed by the processor, cause the apparatus to:
extract a plurality of pairwise comparisons between transaction objects, from a data set stored in the memory, the data set comprising transaction histories of one or more users' transactions with transaction objects over time,
from the stored data set, determine a plurality of user groups, wherein each user group of the plurality of user groups is associated with a common level feature among a set of transaction objects,
for each transaction object, determine a present height associated with the transaction object based on the extracted plurality of pairwise comparisons,
generate, based on a comparison of present heights of transaction objects associated with the common level feature, a data object comprising a ranking of transaction objects for a user group of the plurality of user groups, and
provide the data object to an application to provide a user interface based on the ranking of transaction objects.

9. The apparatus of claim 8, wherein transaction objects of the ranking of transaction objects for the user group to which a user is determined to belong comprise locations within a predetermined radius of an electronic device.

10. The apparatus of claim 8, further comprising:
a network interface, and
wherein the memory further contains instructions, which when executed by the processor, cause the apparatus to:
receive, by the apparatus, over the network interface from a first electronic device, a request for one or more rankings of transition objects, the request comprising information of a first user,
determine, based on the information of a first user, one or more user groups to which the first user belongs, and
send, via the network interface to the first electronic device, a ranking of transaction objects for a user group to which the first user is determined to belong.

11. The apparatus of claim 10, wherein the memory further contains instructions, which when executed by the processor, cause the apparatus to extract the plurality of pairwise comparisons by:
identifying, in the user's transaction history, one or more qualifying pairs of transaction objects,
for each identified pair of transaction objects, extracting features from the user's transaction history,
training a classification model based on the extracted features, and
obtaining, from the classification model, for each pair of transaction objects, a pairwise comparison, the pairwise comparison comprising an indication of which element of the pair of transaction objects is preferred, and a confidence score associated with the indication.

12. The apparatus of claim 11, wherein the extracted features comprise one or more of a transaction count ratio during a feature extraction stage, a transaction count ratio during an interval after two predetermined transaction objects appear in the transaction history, a transaction count ratio between a pair of transaction objects during a predetermined portion of the transaction history, or a transaction count of one or more transaction objects in the transaction history.

13. The apparatus of claim 8, wherein the memory further contains instructions, which when executed by the processor, cause the apparatus to determine the present height associated with the transaction object by:
for each pairwise comparison involving the transaction object, determining a force vector for the transaction object, and
adjusting the present height of the transaction object based on a weighted mean of the determined force vectors for the transaction object.

14. The apparatus of claim 13, wherein the memory further contains instructions, which, when executed by the processor, cause the apparatus to:
for each pairwise comparison involving the transaction object and a comparison object, determine a differential between the present height of the transaction object and a present height of the comparison object, and
when the differential is less than a threshold value, determine the force vector for the transaction object based on a product of a premium-adjusted height difference between the present height of the transaction object and the adjusted present height of the comparison object and a weight.

15. A non-transitory, computer-readable medium containing instructions, which when executed by a processor, cause an apparatus to:
extract a plurality of pairwise comparisons between transaction objects, from a data set stored in a memory, the data set comprising transaction histories of one or more users' transactions with transaction objects over time,
from the stored data set, determine a plurality of user groups, wherein each user group of the plurality of user groups is associated with a common level feature among a set of transaction objects,
for each transaction object, determine a present height associated with the transaction object based on the extracted plurality of pairwise comparisons,
generate, based on a comparison of present heights of transaction objects associated with the common feature, a data object comprising a ranking of transaction objects for a user group of the plurality of user groups, and
provide the data object to an application to provide a user interface based on the ranking of transaction objects.

16. The non-transitory, computer-readable medium of claim 15, wherein transaction objects of the ranking of transaction objects for the user group to which a user is determined to belong comprise locations within a predetermined radius of an electronic device.

17. The non-transitory, computer-readable medium of claim 15, further comprising instructions, which, when executed by the processor, cause the apparatus to:
receive, by the apparatus, over a network interface from a first electronic device, a request for one or more rankings of transition objects, the request comprising information of a first user,
determine, based on the information of a first user, one or more user groups to which the first user belongs, and
send, via the network interface to the first electronic device, a ranking of transaction objects for a user group to which the first user is determined to belong.

18. The non-transitory, computer-readable medium of claim 17, further comprising instructions, which, when executed by the processor, cause the apparatus to extract the plurality of pairwise comparisons by:
identifying, in the user's transaction history, one or more qualifying pairs of transaction objects,
for each identified pair of transaction objects, extracting features from the user's transaction history,
training a classification model based on the extracted features, and
obtaining, from the classification model, for each pair of transaction objects, a pairwise comparison, the pairwise comparison comprising an indication of which element of the pair of transaction objects is preferred, and a confidence score associated with the indication.

19. The non-transitory, computer-readable medium of claim 18, wherein the extracted features comprise one or more of a transaction count ratio during a feature extraction stage, a transaction count ratio during an interval after two predetermined transaction objects appear in the transaction history, a transaction count ratio between a pair of transaction objects during a predetermined portion of the transaction history, or a transaction count of one or more transaction objects in the transaction history.

20. The non-transitory, computer-readable medium of claim 15, further comprising instructions, which, when executed by the processor, cause the apparatus to determine the present height associated with the transaction object by:
for each pairwise comparison involving the transaction object and a comparison object, determine a differential between the present height of the transaction object and a present height of the comparison object, and
when the differential is less than a threshold value, determine a force vector for the transaction object based on a product of a premium-adjusted height difference between the present height of the transaction object and the present height of the comparison object and a weight.
